(19) United States
(12) Patent Application Publication
(10) Pub. No.: US 2023/0126659 A1
(43) Pub. Date: Apr. 27, 2023

(54) UPLINK TIMING ADVANCE ADJUSTMENT AT BEAM SWITCH

(71) Applicant: NOKIA TECHNOLOGIES OY, Espoo (FI)

(72) Inventors: Dmitry Petrov, Espoo (FI); Lars Dalsgaard, Oulu (FI)

(21) Appl. No.: 17/507,217

(22) Filed: Oct. 21, 2021

(51) Int. Cl. H04W 72/12; H04W 72/04; H04W 56/00

(52) U.S. Cl. CPC H04W 72/1268; H04W 72/044; H04W 56/0045

(57) ABSTRACT

Methods, apparatuses, and computer program products for uplink (UL) timing advance (TA) adjustment at beam switch are provided. A method may include, when it is determined that beam change or transmission configuration indication (TCI) state switch should occur for beam(s) originating from non-collocated source nodes, enabling assistance information relating to time difference for a UE. The method may include preparing timing adjustment prediction model(s) configured to predict a timing advance adjustment (TAA) or actual TA that should be applied by the UE at the beam change, using the at least one prepared timing adjustment prediction model to determine the TAA or the actual TA that should be applied by the UE at the beam change. The method may include signaling or assigning the TAA or the actual TA to the UE, or using the TAA to adjust for a UE autonomously adjusted TA value at the beam change.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for uplink (UL) timing advance (TA) adjustment at beam switch.

### BACKGROUND

Examples of mobile or wireless telecommunication systems may include the Universal Mobile Telecommunications System (UNITS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method that may include, when it is determined that beam change or transmission configuration indication (TCI) state switch should occur for one or more beams originating from non-collocated source nodes, enabling assistance information relating to time difference for a UE. The method may include preparing at least one timing adjustment prediction model configured to predict a timing advance adjustment (TAA) or actual TA that should be applied by the UE at the beam change, using the at least one prepared timing adjustment prediction model to determine the TAA or the actual TA that should be applied by the UE at the beam change. The method may include signaling or assigning the TAA or the actual TA to the UE, or using the TAA to adjust for a UE autonomously adjusted TA value at the beam change.

An embodiment may be directed to an apparatus including at least one processor and at least one memory comprising computer program code. The at least one memory and computer program code configured, with the at least one processor, to cause the apparatus at least to perform: when it is determined that beam change or transmission configuration indication (TCI) state switch should occur for one or more beams originating from non-collocated source nodes, enabling assistance information relating to time difference for a user equipment (UE); preparing at least one timing adjustment prediction model configured to predict a timing advance adjustment (TAA) or actual timing advance (TA) that should be applied by the user equipment (UE) at the beam change; using the at least one prepared timing adjustment prediction model to determine the timing advance adjustment (TAA) or the actual timing advance (TA) that should be applied by the user equipment (UE) at the beam change; and signaling or assigning the timing advance adjustment (TAA) or the actual timing advance (TA) to the user equipment (UE), or using the timing advance adjustment (TAA) to adjust for a user equipment (UE) autonomously adjusted timing advance (TA) value at the beam change.

An embodiment may be directed to a non-transitory computer readable medium comprising program instructions stored thereon for performing at least the following: when it is determined that beam change or transmission configuration indication (TCI) state switch should occur for one or more beams originating from non-collocated source nodes, enabling assistance information relating to time difference for a user equipment (UE); preparing at least one timing adjustment prediction model configured to predict a timing advance adjustment (TAA) or actual timing advance (TA) that should be applied by the user equipment (UE) at the beam change; using the at least one prepared timing adjustment prediction model to determine the timing advance adjustment (TAA) or the actual timing advance (TA) that should be applied by the user equipment (UE) at the beam change; and signaling or assigning the timing advance adjustment (TAA) or the actual timing advance (TA) to the user equipment (UE), or using the timing advance adjustment (TAA) to adjust for a user equipment (UE) autonomously adjusted timing advance (TA) value at the beam change.

### BRIEF DESCRIPTION OF THE DRAWINGS

For proper understanding of example embodiments, reference should be made to the accompanying drawings, wherein:

FIG. 1 illustrates an example of beam/transmission configuration indication (TCI) switch, according to one example;

FIG. 2 illustrates another example of beam/TCI state switch, according to one example;

FIG. 3 illustrates an example of beam specific downlink (DL) reference signal (RS), according to an embodiment;

FIG. 4 illustrates an example of change in propagation delay (PD) and timing advance (TA) for a UE that is moving, according to an embodiment;

FIG. 5 illustrates an example of handover positions and corresponding propagation map, according to one example;

FIG. 6 illustrates an example flow diagram of a method, according to an embodiment;

FIG. 7 illustrates an example signaling diagram of network-controlled TA adjustment, according to an embodiment;

FIG. 8 illustrates an example signaling diagram of UE autonomous TA change, according to an embodiment;

FIG. 9 illustrates an example flow diagram of a method, according to an embodiment;

FIG. 10 illustrates an example of a distributed model training and update architecture, according to an embodiment;

FIG. 11 illustrates an example signalling diagram of network-controlled TA adjustment with a prediction model, according to certain embodiments;

FIG. 12 illustrates an example signalling diagram of a UE autonomous TA change at TCI-state switch with a prediction model, according to certain embodiments;

FIG. 13 illustrates an example flow diagram of a method, according to an embodiment;

FIG. 14A illustrates an example block diagram of an apparatus, according to an embodiment; and

FIG. 14B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for UL TA adjustment at beam switch, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain example embodiments may generally relate to UL TA and/or beam management. For instance, some example embodiments can be applicable to high-speed train communications in millimetre waves (mmWaves). Work is ongoing in relation to high-speed train (HST) communication in frequency band 2 (FR2). In FR2, it is a common understanding that both the User Equipment (UE), which may also be referred to as customer premises Device (CPE), and the network will use beamforming to ensure a sufficient link budget. For the FR2 HST, two main deployment scenarios are currently under consideration. These deployment scenarios are (1) remote radio head (RRH) transmission in a uni-directional manner along the track, and (2) RRH transmission in a bi-directional manner along the track.

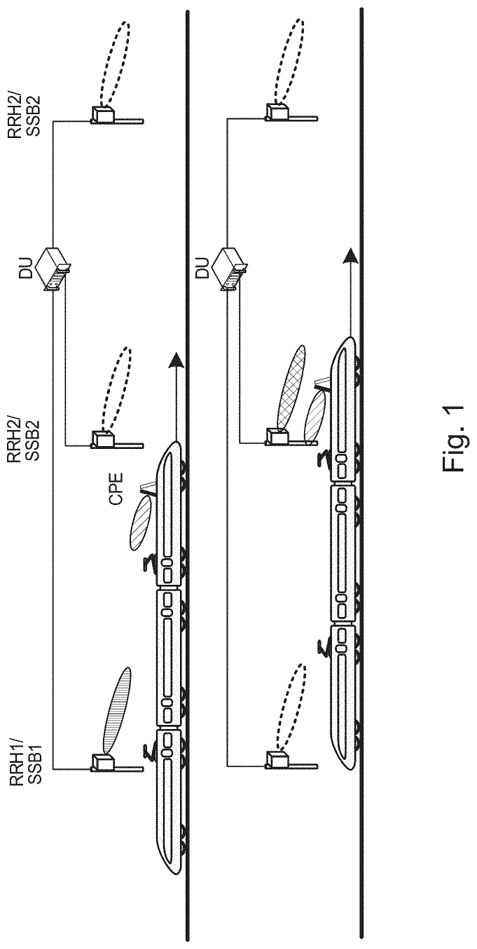

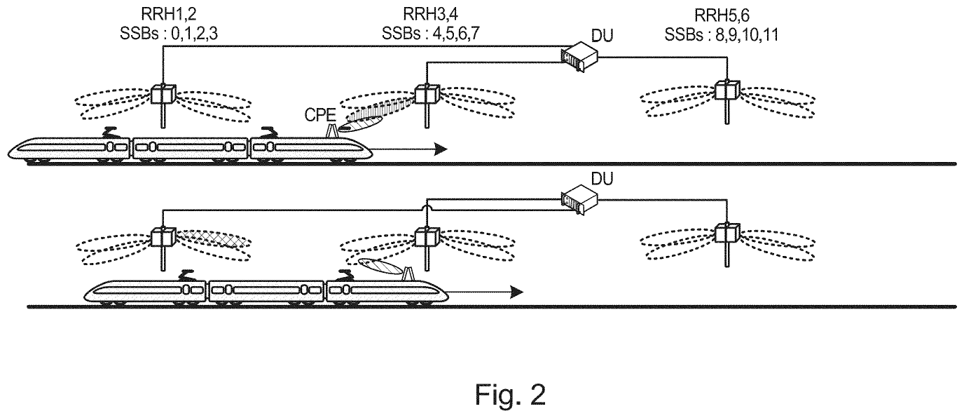

FIG. 1 illustrates an example of a beam/transmission configuration indication (TCI) state switch for a uni-directional HST FR2 deployment. In the example of FIG. 1, the RRHs (RRH1, RRH2) transmit in a uni-directional manner. FIG. 2 illustrates an example of a beam/TCI state switch for a bi-directional HST FR2 deployment. Therefore, in the example of FIG. 2, the RRHs (RRH1,2, RRH3,4, RRH5,6) transmit in a bi-directional manner.

More specifically, as can be seen from the examples of FIG. 1 and FIG. 2, the assumption is that the gNB can have one or more RRHs per cell in use to make the deployment more efficient in FR2. Each RRH can be seen as an Access Point (AP) from the UE point of view. APs are connected to one cell and, hence, are seen as one cell by the UE. Each RRH may transmit one or more downlink (DL) beams. Which of the DL beams the UE is to use for DL reception may be controlled by the gNB based on UE-assisted beam management (BM) measurements and reporting. Therefore, the network may configure the UE with one or more BM reference signals (RSs) to measure the beams. These RSs can be synchronization signal block (SSB), channel state information reference signal (CSI-RS) or both. The UE may measure and then report the BM measurements to the network using layer 1 reference signal received power (L1-RSRP) reporting and, based on these results, the network can indicate (or request) to the UE which DL RS to use for DL reception (i.e., which DL beam is to be monitored by the UE for DL reception). This concept is also known as beam management (BM).

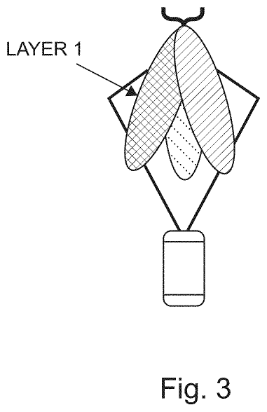

The concept of BM was developed to enable fast and efficient change of DL (and UL) beam to be used by the UE. When developing the concept, the baseline assumption has been that the transmission point (e.g., the AP, transmission-reception point (TRP), or similar) for the DL beams used in the serving cell are collocated. Hence, the transmission from the cell is from the same point in space as seen from the UE. Then, the UE can use this colocation assumption to direct its reception (Rx) beam settings correctly (and accordingly), as illustrated in the example of FIG. 3. More specifically, FIG. 3 illustrates an example of beam specific DL RS. In the example of FIG. 3, each DL beam from the same cell (known by the SSB) will have separate DL RS (e.g., SSB and/or CSI-RS). Based on this information, the UE knows how to direct its Rx settings.

One part of the communication between a transmission point (e.g., RRH, AP or TRP) and UE is the DL link. The UE has to be synchronised to the network and the UE will track the DL timing of the serving cell continuously in order to enable DL reception from the network. Another part of the communication is the UL transmission, where the UE needs to transmit the UL signal to the network. This has to be done in a timely manner such that the network receives all the UL signals from the UEs in the cell within a given time window. To enable this, the UEs transmit in UL accounting for the DL delay and the transmission delay (TD). Thus, the UEs need to transmit in ‘advance’ compared to the received reference DL frame. This advanced transmission and how early the UE needs to advance the transmission is controlled by the network and by the timing advance (TA). Correct TA in wireless communication enables the network to decode the UL transmissions, and the UE is not allowed to transmit in UL without valid TA.

Handling of TA in NR (and legacy systems) may be performed based on an initial acquisition of a valid TA value, and the tracking and updating of the valid TA value. An initial valid TA value can be acquired using random access (RA). During this RA procedure, the UE transmits a preamble in UL. The network uses the preamble to calculate a suitable TA value for the UE that has transmitted the preamble. The network then responds to the preamble transmission with a valid TA to be applied by the UE. This is usually referred to as a random access response (RAR) message and is part of the RA procedure. There can be two slightly different RA procedures. One is contention-based RA (CB-RA) procedure, and the other is non-contention-based (or contention-free) RA (CFRA) procedure. The main difference between these procedures is whether the UE has a preassigned UE-specific preamble from which the network can identify the UE that has transmitted the received preamble. This is called the contention-free RA (CFRA) procedure. In the contention-based RA (CB-RA) procedure, the UE is not assigned a preamble but selects one among a group of preambles and transmits the selected preamble to the network. The CB-RA procedure contains two more steps (i.e., longer procedure) due to including the steps of contention resolution.

Once the UE has been assigned a TA value, the UE can track the DL frame timing of the serving cell and perform small-scale autonomous TA adjustments to account for the changed one-way DL delay due to UE movement. The network can also track a UE in UL (using network-specific implementation and algorithm) to track that the received signal from the UE remains within the reception window. If needed, for example if the UL transmission from the UE needs to be adjusted to remain within the reception window, the network may send a TA command (TAC) to the UE such that the UE adjusts its UL transmit timing accordingly. This way, the UL signal from the UE (and the other UEs in the cell) can be maintained to be received within the network reception window.

As can be recognized from the examples of FIG. 1 and FIG. 3 introduced above, the FR2 HST scenario differs from the baseline assumption used in 3GPP Release-15 when developing the BM concept. In the HST case, when using RRHs for covering the track, the RRH are not collocated. Hence, even if RRHs are seen as one cell, the RRHs locations are physically different and cannot be regarded as being collocated. That is quite different assumption than used when developing the BM concept and therefore new challenges arise.

One such challenge is that the basic assumption that UL synchronization and TA used in one beam does not change when changing the beam or TCI state (due to collocation assumption) may not always be true. Thus, when considering the scenario where the RRHs of the same cell are located physically at separate locations, re-use of the UL synchronization/TA is now not always possible.

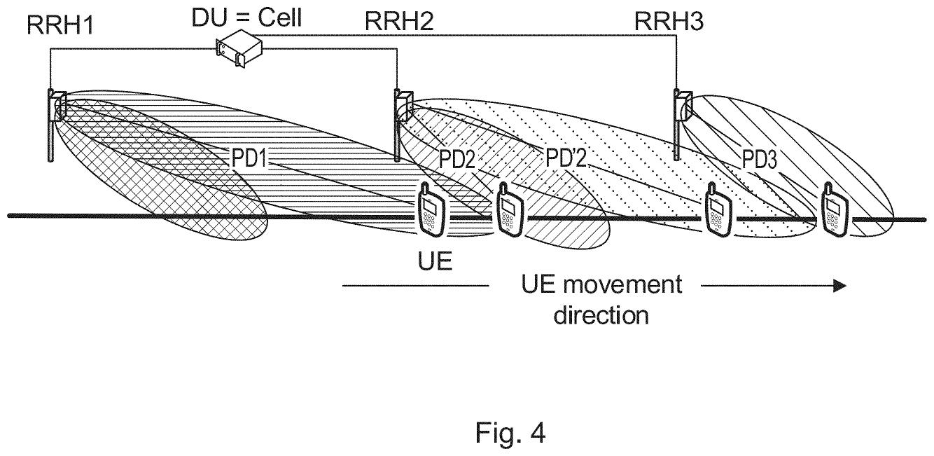

As the UL timing is relative to the DL timing, when there is a change in the DL timing (big or small), there will also be a change in the UL transmit timing. When the serving beam, e.g., in the uni-directional HST scenario, is switched from one RRH to another, the DL propagation delay difference (dPD) between the RRHs can be significant. FIG. 4 illustrates one example of the change in propagation delay (PD) and TA for UE (e.g., train CPE) moving over a railway track to the right. For example, for 700 m inter-RRH distance dPD=PD2−PD1 is around 2.3 μs, which is almost five times more than the cyclic prefix (CP) length of 0.57 μs at 120 kHz sub-carrier spacing (SCS) in FR2. Therefore, if the change in UL transmit timing due to the change in DL propagation delay is not timely compensated by the TA adjustment, the UL connection quality will either considerably degrade or will break completely.

Currently, two approaches to compensate for the large change in propagation delay due to the RRH switch are being considered. The first approach is a network-based TA adjustment, where the network signals necessary adjustment value. The second approach is a UE autonomous large TA adjustment. However, in both cases, new operations may need to be performed at every beam switch (or at least some) which increases the BM switch delays at the system level, before the data transmission with correct TA can be initiated in the new beam. Additionally, it may increase overall signalling overhead.

For the first approach, the network estimates the TA. This can be done by the UE informing the network about the change in propagation delay between the source and target RRHs (dPD), such that network can signal new TAC with new adjusted TA value to the UE. Alternatively, the network can instruct the UE to send PRACH preamble to the target RRH in the target beam, such that the network can measure TA on its own.

In the second approach, the UE may adjust the applied TA value autonomously. Such TA adjustment may be large and even beyond currently applied TA. The adjusted TA value used on the UE side would be informed to the network to ensure alignment of applied TA between the UE and gNB. Again, as an alternative, the network can instruct the UE to send PRACH preamble to the target RRH in the target beam such that the network can measure TA on its own.

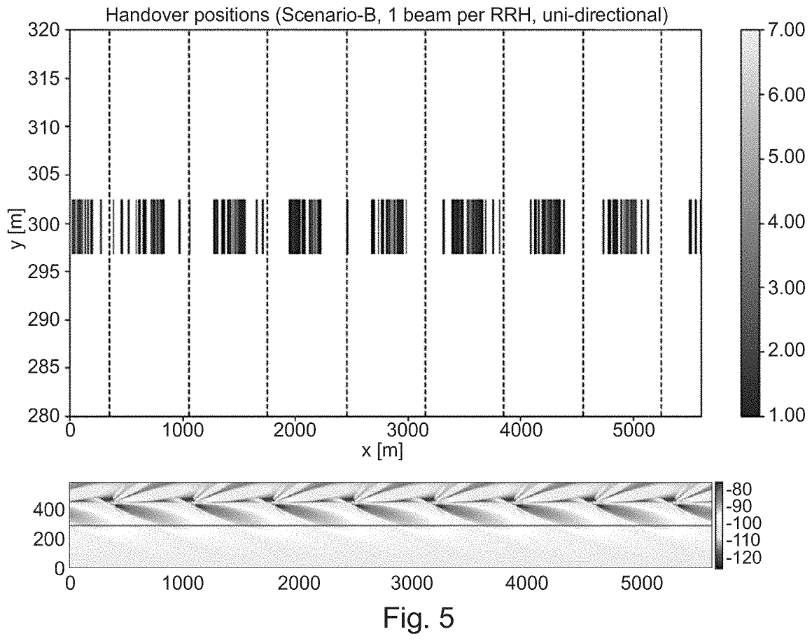

Even though the HST FR2 scenario represents a rather predefined and deterministic UE mobility scenario, the physical locations of where beam changes or handovers occur are not fixed. For example, distribution of handover (HO) locations provided by sophisticated system-level simulator at the presence of phase noise is shown in the example of FIG. 5. In particular, FIG. 5 illustrates handover positions and the propagation map (below) in a HST FR2, 1 beam per RRH, uni-directional deployment. As far as the exact RRH switch location is not known, it is also not possible to signal a fixed predefined value of TA adjustment to the UE at beam switch if this is needed.

As will be discussed in detail below, one problem that can be solved, according to example embodiments described herein, is the minimization of redundant network signalling and/or need for PRACH preamble transmissions introduced by the need to compensate for large changes in the propagation delays when a beam change is performed between non-collocated RRHs.

It should be noted that, although certain example embodiments are described herein in reference to a HST scenario, example embodiments are not limited to such a scenario. Rather, it should be understood that example embodiments can be applicable to any scenario benefiting from reducing redundant network signalling and/or reducing the need for PRACH preamble transmissions. Furthermore, it is noted that when reference is made to a RRH herein, the RRH may be interchangeable with a TRP, AP, RU, and/or cell, or the like. Thus, example embodiments should not be considered to be limited to the use of RRH, but are applicable to other types of network nodes as outlined elsewhere herein.

Some example embodiments provide methods for minimizing signalling overhead and/or PRACH preamble transmissions, when performing beam changes/TCI state changes among beam originating from non-collocated sources (e.g., RRHs/TRPs/Aps/cells). Certain embodiments are explained using the FR2 HST scenario as an example, but example embodiments are not restricted to that scenario. In general, example embodiments may be applicable to any scenario that involves (steady) mobility (e.g., over railway tracks, highways, or the like, etc.) when the beam change/TCI state switch may happen between distributed APs, including, e.g., mTRP BM, inter-cell BM and L1-mobility. However, example embodiments may also be applicable even if mobility is not involved, e.g., non-mobile scenario.

An example embodiment provides a machine learning (ML) solution enabling reduction of signalling overhead and/or faster beam switch. A method, according to one embodiment, can learn the need for TA and the values of applied TA from the history of one or more UEs' beam switches. Based on the input parameters, the network will be able to assign TA to the UE at beam switch when there is a need for updating the TA.

In one example embodiment, the network can recognize that the UE switches between two DL beams that use different TA in UL (e.g., inter-cell MIMO/BM). In this case, the network may provide the UE with the necessary (previously used TA) at TCI state change.

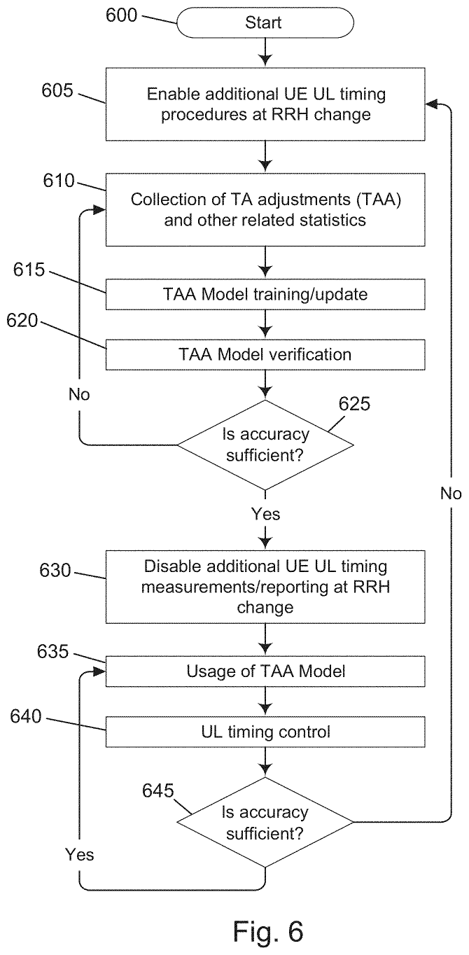

FIG. 6 illustrates an example flow diagram of a process for TA change model preparation and usage, according to one embodiment. In certain example embodiments, the flow diagram of FIG. 6 may be performed by a network entity or network node in a communications system, such as LTE or 5G NR. In some example embodiments, the network entity performing the method of FIG. 6 may include or be included in a base station, access point or node, node B, eNB, gNB, gNB-DU, gNB-CU, NG-RAN node, 5G node, transmission-reception point (TRP), high altitude platform stations (HAPS), relay station, or the like.

As illustrated in the example of FIG. 6, the method may begin at 600. At 605, the method may include enabling or disabling of additional UL timing procedures at TCI state switch and/or RRH change. The additional uplink timing procedures may be those that are not normally performed during UL synchronization. As further illustrated in the example of FIG. 6, the method may include, at 610, collecting of TA adjustments (TAA) and/or other related statistics. In an embodiment, depending on the applied TAA scheme at RRH change, additional procedures may be performed. For example, these additional procedures may include reporting of UE measurements of propagation delay differences between source and target RRHs, reporting of TA value applied autonomously by the UE, signaling of estimated TA value to be used after beam switch, triggering a transmission of PRACH preamble for TA estimation on the network side (e.g., PDCCH order), signaling of resources for CF PRACH transmission, transmission of PRACH preamble, and/or UE reporting of RSRP measurement results from involved beams and/or relative difference, etc.

As further depicted in the example of FIG. 6, the method may include, at 615, TAA model training and/or update and, at 620, TAA model verification. In an embodiment, the outcome of the TAA model may be the TA adjustment/change or actual TA that is to be applied at the UE at the beam change. In one example, the output of the TAA model may include the TA to be applied by the UE, may include an estimate of the UE autonomous TA, and/or may include which TA value would be used by the UE (e.g., based on autonomous adjustment) and would need to be accounted for at the gNB. In some embodiments, the TAA model prediction does not necessitate explicit TA measurement and/or reporting.

In an embodiment, one implementation of the TAA model can be based on deep neural network (DNN) architecture that takes several network and/or UE state and/or parameters as input, e.g., RSRP values to source and target RRHs, UE speed, UE location, source/target SSB/beam indexes, inter-RRH distance, etc.

According to some embodiments, the TAA model preparation stage 615 may include the collection of certain statistics for model training and/or the training of the model using collected dataset. In an embodiment, the TAA model verification 620 may include the verification of the model predication accuracy based on new RRH switches. According to certain embodiments, several approaches can be used to train the TAA model. For example, in the case when the deployment is rather uniform, one TAA model can be used for a large area covered by many cells. Alternatively, in certain embodiments, individual models can be trained on a cell or even RRH level. Additionally, in an embodiment, a federated learning approach can be used to exchange information between such individual models to accelerate training and avoid overfitting.

As also illustrated in the example of FIG. 6, the method may include, at 625, determining whether the output of the TAA model is sufficiently accurate. If it is determined that the output of the TAA model is not sufficiently accurate, then the method may return to the collection of TAA and/or other related statistics at 610. If it is determined that the output of the TAA model is sufficiently accurate, then the method may include, at 630, disabling additional UE UL timing measurements and/or reporting at RRH change. For example, after the model is prepared, the overhead signalling, reporting and/or transmissions can be disabled at 630. Based on the learning, the network may, at 635, use the results of the TAA model to explicitly assign TA to the UE at beam change and/or account for the UE autonomously adjusted TA value at the gNB.

After the TAA learning has ended, the method may include, at 640, tracking UL timing control For example, the network may continue to track the UL timing of the UE because the default/legacy closed-loop network-control-based TA mechanism is still in use. At 645, the method may include determining if the UL timing is sufficiently accurate. As a result, any errors or mismatch in UL timing can be discovered by the network or gNB. If it is determined that the accuracy is not sufficient, then the method may return to 610 where additional procedures can be enabled back, and the TAA model update is triggered. If it is determined that the accuracy is sufficient, then the method may proceed with the use of the TAA model at 635.

As a result of the example method illustrated in FIG. 6, signaling overhead during beam switch can be minimized, the usage of PRACH resources can be minimized, the time needed to acquire or assign the correct UL TA after beam switch can be reduced, and/or beam switch delays can be reduced (e.g., faster re-start of DL and UL data transmission to the target RRH after beam switch).

In the following, examples of some applications of certain embodiments will be discussed. For instance, certain embodiments can be applied when there is network-controlled TA adjustment, and/or when there is large autonomous TA change at RRH change, for instance, in a NR HST FR2 scenario (as an example scenario). It should again be noted that example embodiments are not restricted in use or applicability to NR and/or FR2 HST scenario, but can be applied in general.

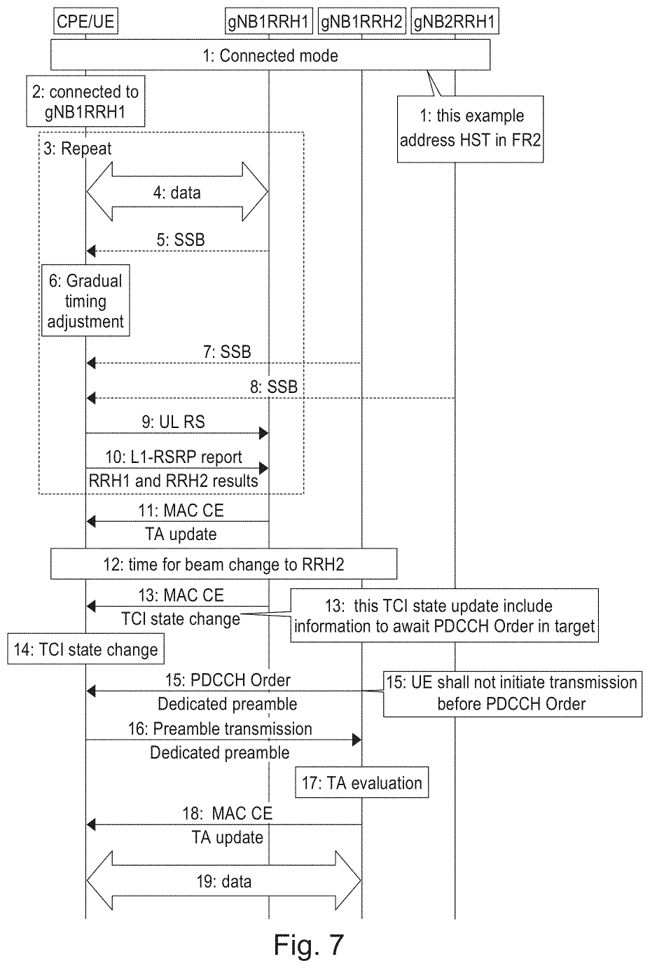

FIG. 7 illustrates an example signaling diagram of network-controlled TA adjustment at TCI-state switch, according to certain embodiments. In the example of FIG. 7, at as shown at 1, it is assumed that the CPE (or UE in general) is in connected mode and, as shown at 2, connected to gNB1 using RRH1 (gNB/RRH1). In this example, gNB1 may also include RRH2 (gNB/RRH2), and another RRH1 connected to gNB2 (gNB2/RRH1) may be present in the system as a potential coming target. In the example of FIG. 7, at 4, data may be exchanged between the CPE/UE and gNB1/RRH1. At 5, gNB1/RRH1 may transmit SSB to the CPE/UE, which may perform gradual timing adjustment as shown at 6. At 7 and 8, gNB1/RRH2 and gNB2/RRH1 may respectively transmit SSB to the CPE/UE. At 9, the CPE/UE may transmit UL RS to gNB1/RRH1 and may transmit, at 10, a L1-RSRP report with RRH1 and RRH2 results. As shown at 3, procedures 4 to 10 may be repeated, if needed. At 11, gNB1/RRH1 may transmit MAC CE TA update to the CPE/UE and, at 12, it may be determined that it is time for beam change to RRH2.

At the TAA model training stage, procedures 13, 15, 16, 17 and 18 presented in the example of FIG. 7 are enabled. As further illustrated in the example of FIG. 7, at 13, gNB1/RRH1 may transmit the MAC CE TCI state change to the CPE/UE. This TCI state update may include information to await PDCCH order in the target node, e.g., gNB1/RRH2. At 14, the TCI state change occurs. At 15, gNB1/RRH2 may transmit PDCCH order dedicated preamble to the CPE/UE. In an embodiment, the CPE/UE does not initiate transmission before the PDCCH order. As a result, at 16, the CPE/UE may perform preamble transmission of a dedicated preamble to gNB1/RRH2. At 17, gNB1/RRH2 may evaluate the needed value of TA in UL. This value may be used as the ground truth for model training and verification. Then, at 18, gNB1/RRH2 may transmit MAC CE TA update, which may include the necessary TAA with TAC, to the CPE/UE. As shown at 19, data may then be exchanged between the CPE/UE and gNB1/RRH2.

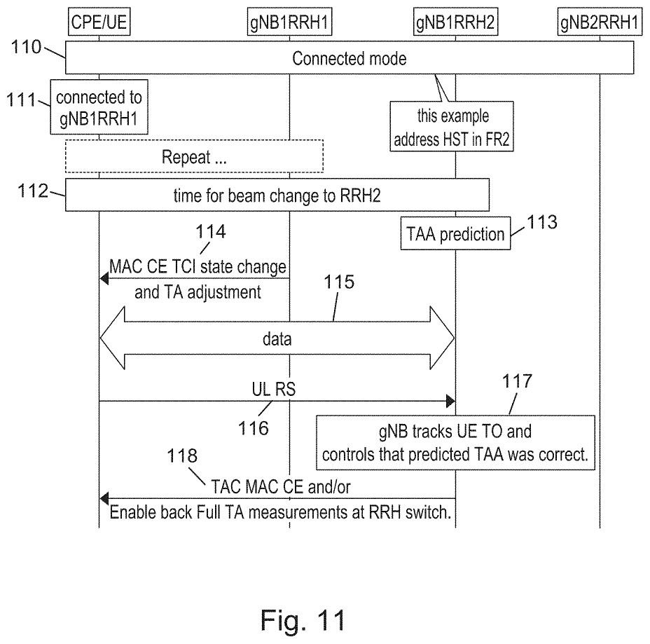

According to certain embodiments, after the TAA model is trained and verified, instead of four procedures 13, 15, 16, 17, 18 shown in FIG. 7, just two steps would be needed: prediction of needed TA adjustment and its signalling to the UE, e.g., with TAC or even together with TCI change MAC CE. FIG. 11 discussed in detail below illustrates such a procedure with reduced signaling.

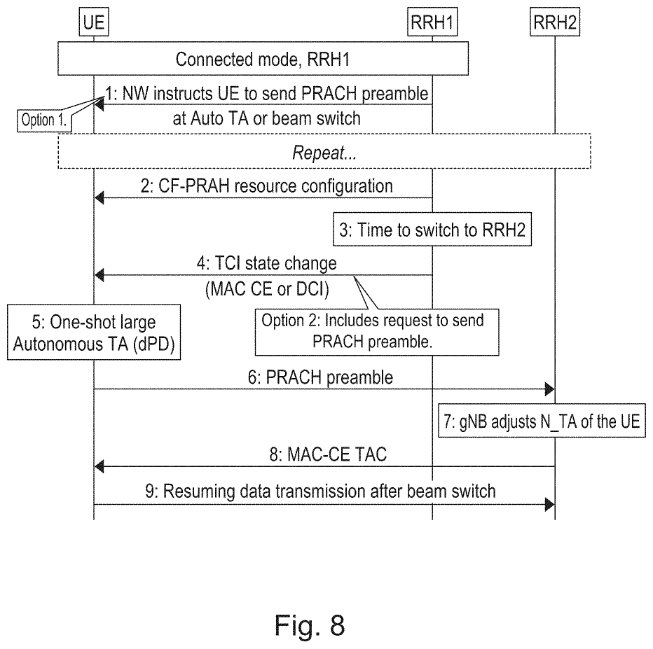

FIG. 8 illustrates an example signaling diagram of UE autonomous TA change at TCI-state switch, according to certain embodiments. In the example of FIG. 8, it is assumed that the UE is in connected mode and connected to RRH1. As shown at 1 of FIG. 8, the network (RRH1) may instruct the UE to send PRACH preamble at autonomous TA or beam switch. In the example of FIG. 8, at 2, RRH1 may transmit CF-PRACH resource configuration to the UE. At 3, RRH1 may determine that it is time to switch to RRH2. In the example of FIG. 8, at 4, RRH may transmit TCI state change, e.g., in a MAC CE or DCI, to the UE. In one embodiment, the TCI state change may include a request to send PRACH preamble. At 5, the UE may perform one-shot large autonomous TA (dPD) and, at 6, the UE may transmit PRACH preamble to RRH2.

It is noted that, at the model training stage, procedures 2, 6, 7 and 8 illustrated in the example of FIG. 8 are enabled. In the example of FIG. 8, at 7, the network (RRH2) may measure and update the actual value of time offset (TO) in UL of the UE. This value may be used as the ground truth for model training and verification. Then, at 8, the necessary TA adjustment may be signaled to the UE with MAC-CE TAC. At 9, data transmission after beam switch may be resumed.

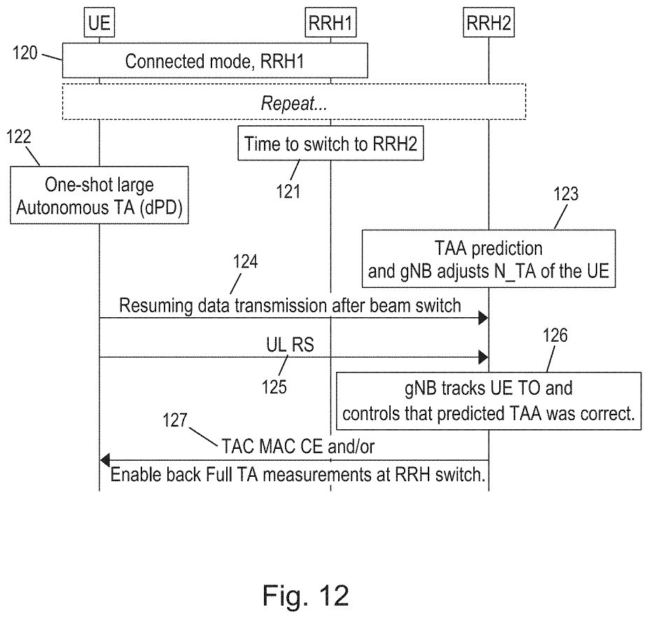

According to certain embodiments, after the model is trained and verified, instead of four procedures 2, 6, 7, 8 illustrated in the example of FIG. 8, just one procedure would be needed: prediction of TAA, i.e., of the TA change done autonomously by the UE, and update of the corresponding N_{TA} record at gNB. FIG. 12, which is discussed in detail below, illustrates an example of such a process with the reduced number of procedures.

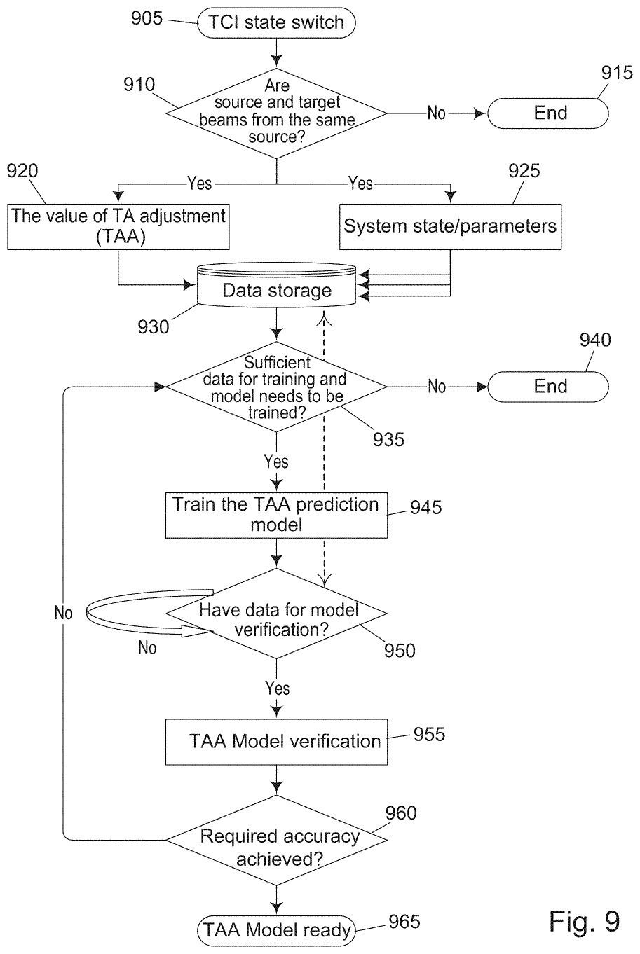

During the TAA model preparation stage, the additional steps shown in the above-discussed example diagrams of FIG. 7 and FIG. 8 are enabled. As a result, the network possess accurate information about the changes and/or adjustments in the TA of the UE at every TCI state switch. FIG. 9 illustrates an example flow diagram of TA adjustment model preparation (i.e., TAA model training process), according to an embodiment.

As illustrated in the example of FIG. 9, at 905, TCI state switch occurs. At 910, it is determined if the source and target beams are from the same source or node. It is noted that the term “source” as used herein may refer to a source of a transmission, e.g., the source of the DL beam RSs for beam management used by the UE for steering a Rx beam correctly. In certain example embodiments, the source may be a RRH, TRP, AP, RU, and/or cell, or the like.

As further illustrated in the example of FIG. 9, if it is determined that the source and target beams are not from the same source, then the process may end at 915. If it is determined that the source and target beams are from the same source, the method may include, as shown at 920 and 925, collecting and storing the value of TAA and system state/parameters in a data storage 930. According to certain example embodiments, the system state and/or parameters that are collected with TA/TAA statistics can include, but are not limited to, for example, RSRP value of the relevant RS used by the source and/or target RRHs, UE location, source/target SSB/beam indexes, inter-RRH distance, UE speed, UE/CPE capabilities, type of deployments, time difference, e.g., in frame synchronization reception, TA estimation, currently used TA, TA Adjustment information, frequency offset (FO), etc.

As further illustrated in the example of FIG. 9, at 935, it may be determined if there is sufficient data for training and if the model needs to be trained. If not, then the process may end at 940. If yes, then the process may proceed to train the TAA prediction model at 945. At 950, it may be determined if there is data available for model verification. If so, then the process may proceed to the TAA model verification at 955. At 960, it may be determined whether a required accuracy for the TAA model has been achieved. If the required accuracy has not been achieved, then the process may return to 935 to determine whether there is sufficient data for training and if the model needs to be trained. If the required accuracy has been achieved, then the process may conclude with the TAA mode being ready at 965.

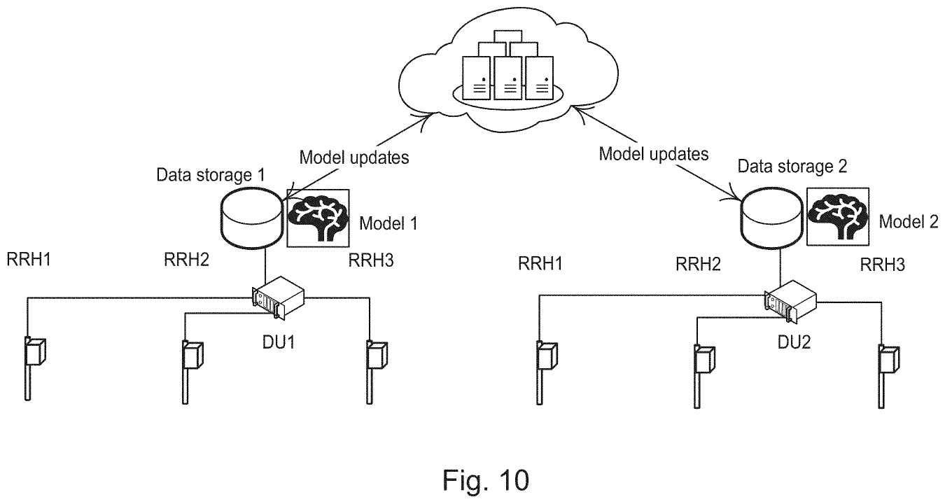

It is noted that the TAA model can be trained and updated either independently for each pair of network nodes (e.g., RRHs, APs, or TRPs) on the cell level, or for a larger segment of the network. Additionally, a federated learning approach can be applied if multiple individual models are used to accelerate the learning and to exchange the information between different parts of the network and avoid model overfitting. FIG. 10 illustrates one example of a distributed model learning and update architecture.

As described above with respect to the network controlled TA adjustment and UE autonomous TA change examples (i.e., FIGS. 7 and 8), after the model is validated, a substantial part of the signalling, measurements and reporting related to TA adjustment as RRH switch can be disabled. According to certain embodiments, with the TA adjustment prediction model in use, the entire UL TA adjustment process can be reduced to just a few steps, as shown in the examples of FIG. 11 and FIG. 12, respectively.

FIG. 11 illustrates an example signaling diagram of network-controlled TA adjustment with TO prediction model enabled, according to some embodiments. As depicted in the example of FIG. 11, at 110, it is assumed that the CPE (or UE in general) is in connected mode and, as shown at 111, connected to gNB1 using RRH1 (gNB/RRH1). In the example of FIG. 11 (similar to FIG. 7), gNB1 may also include RRH2 (gNB/RRH2), and another RRH1 connected to gNB2 (gNB2/RRH1) may be present in the system as a potential coming target. As shown at 112 in FIG. 11, it may be determined that it is time for beam change to RRH2. The gNB1/RRH2 may perform, at 113, TAA prediction as discussed elsewhere herein. In the example of FIG. 11, at 113, gNB1/RRH1 may transmit the MAC CE TCI state change and TA adjustment to the CPE/UE. At 115, data may be exchanged between the CPE/UE and gNB1/RRH2. The CPE/UE may then transmit, at 116, UL RS to the gNB1/RRH2. At 117, the gNB1/RRH2 may track UE TO and control that predicted TAA was correct. As shown at 118, the gNB1/RRH2 may transmit, to the CPE/UE, TAC MAC CE and/or re-enable full TA measurements at RRH switch.

FIG. 12 illustrates an example signaling diagram of UE autonomous TA change at TCI-state switch with TO prediction model enabled, according to some embodiments. In the example of FIG. 12, as shown at 120, it is assumed that the UE is in connected mode and connected to RRH1. At 121, RRH1 may determine that it is time to switch to RRH2. At 122, the UE may perform one-shot large autonomous TA (dPD). In the example of FIG. 12, at 123, the network (RRH2) may perform TAA prediction, measure and update the actual value of time offset (TO) in UL of the UE. At 124, the UE may resume data transmission after the beam switch and, at 125, the UE may transmit UL RS to RRH2. As further illustrated in the example of FIG. 12, at 126, RRH2 may track UE TO and control that predicted TAA was correct. At 127, RRH2 may transmit, to the UE, TAC MAC CE and/or re-enable full TA measurements at RRH switch.

In the examples of FIGS. 11 and 12, the network may continue tracking and evaluating the UL transmission timing, e.g., based on the received UL RS(s) or other signals. Thus, if at some point the quality of prediction starts to decay for some reason (e.g., changed environmental conditions), a corrective TAC can be issued, or the procedure can fall back to the full schemes illustrated in the examples of FIGS. 7 and 8.

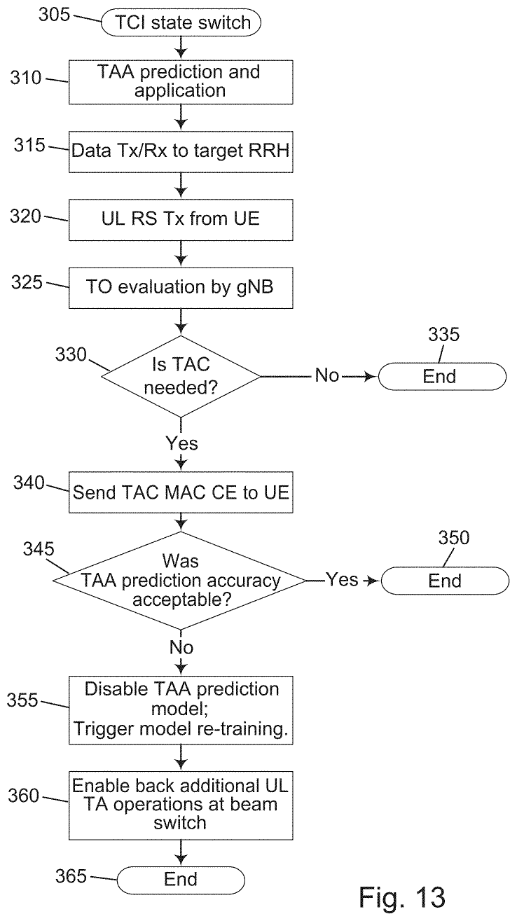

FIG. 13 illustrates an example flow diagram of a method demonstrating the usage of TAA prediction model, according to one embodiment. As illustrated in the example of FIG. 13, at 305, TCI state switch may occur. At 310, TAA prediction and application may be performed. At 315, data transmission and/or reception to a target RRH may be performed. At 320, the UE may perform UL RS transmission. At 325, TO evaluation may be performed by the gNB. At 330, it may be determined whether TAC is needed. If it is determined that TAC is not needed, then the method may end at 335. If it is determined that TAC is needed, then the method may include, at 340, sending TAC MAC CE to the UE. At 345, it may be determined if the TAA prediction accuracy is acceptable. If it is determined that the TAA prediction accuracy is acceptable, then the method may end at 350. If it is determined that the TAA prediction accuracy is not acceptable, then the method may include, at 355, disabling the TAA prediction model and triggering re-training of the TAA model. At 360, additional UL TA operations at beam switch may be re-enabled and, at 365, the method may end.

It is noted that some of the examples discussed above may be directed to the cases where the jump in propagation delay and a need to TAA model is caused by the TCI state switch triggered by the network. However, example embodiments can be applied when autonomous TA is performed due to some other reasons, e.g., UE-driven beam change.

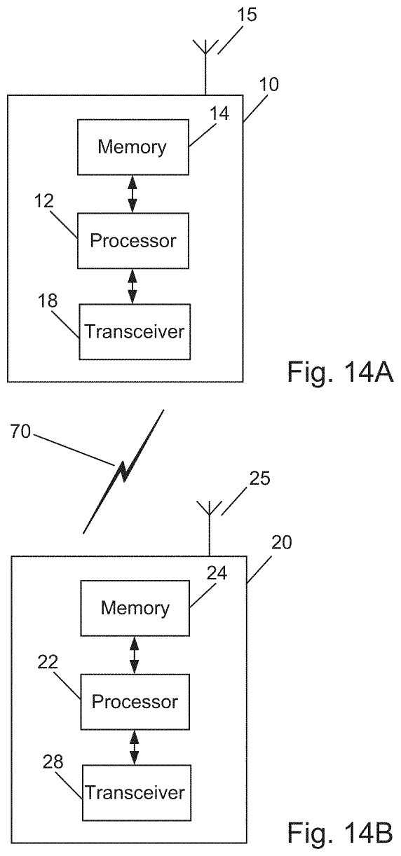

FIG. 14A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, RRH, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 14A.

As illustrated in the example of FIG. 14A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 14A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, RRH, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 6-13, or any other method described herein. In some embodiments, as discussed herein, apparatus 10 may be configured to perform a procedure relating to UL TA adjustment at beam switch, for example.

According to an embodiment, apparatus 10 may be controlled by memory 14 and processor 12 to, when it is determined that beam change or TCI state switch should occur for one or more beams originating from non-collocated source nodes, enable assistance information relating to time difference (e.g., referred to as the additional uplink timing procedures outlined above in the examples of FIGS. 6 and 13) for a UE. In certain embodiments, the assistance information relating to time difference may include one or more of: reporting of UE measurements of propagation delay differences between the source nodes and target nodes, reporting of TA value applied autonomously by the UE, signaling of estimated TA value to be used after the beam switch, triggering a transmission of physical random access channel (PRACH) preamble for TA estimation on a network side, resources for contention-free (CF) PRACH transmission, transmission of PRACH preamble, and/or UE reporting of reference signal received power (RSRP) measurement results from involved beams and/or relative difference of the RSRP measurement results. According to an embodiment, the source nodes may include one or more RRHs, TRPs, and/or APs.

In some embodiments, apparatus 10 may be controlled by memory 14 and processor 12 to prepare at least one timing adjustment prediction model configured to predict a TAA or actual TA that should be applied by the UE at the beam change. According to certain embodiments, to prepare the at least one timing adjustment prediction model, apparatus 10 may be controlled by memory 14 and processor 12 to train and/or update the at least one timing adjustment prediction model using a set of TAAs and/or system parameters. For example, the set of TAAs used to train or update the prediction model may include values of applied TA from the history of one or more UEs' beam switches, and/or may include other TAA statistics. In some embodiments, the system parameters may include one or more of: RSRP value of a relevant reference signal (RS) used by the source nodes and target nodes, UE location, source or target synchronization signal block (SSB) or beam indexes, inter-remote radio head (RRH) distance, UE speed, UE capabilities, type of deployments, time difference in frame synchronization reception, TA estimation, currently used TA, TAA information, and/or FO.

According to certain embodiments, to prepare the at least one timing adjustment prediction model, apparatus 10 may be controlled by memory 14 and processor 12 to verify the at least one timing adjustment prediction model, and to determine that a required accuracy of the output of the timing adjustment prediction model is achieved, and that the at least one timing adjustment prediction model is ready for use.

In one embodiment, the timing adjustment prediction model may be a deep neural network (DNN) configured to take one or more network parameters and/or UE state parameters as input, and configured to output at least one of the TAA or actual TA that should be applied by the UE at the beam change. According to certain embodiments, when an accuracy of the output of the at least one timing adjustment prediction model is sufficient, apparatus 10 may be controlled by memory 14 and processor 12 to disable at least one of signaling, measurements or reporting relating to timing adjustment (TA) at source node switch.

In an embodiment, one of the at least one timing adjustment prediction model may be trained and used for an area covered by multiple cells. In a further embodiment, each of the at least one timing adjustment prediction model may be trained and used on an individual cell level or individual RRH level. In yet a further embodiment, the at least one timing adjustment prediction model may include multiple timing adjustment prediction models configured to exchange information between the models to accelerate training and avoid overfitting.

According to an embodiment, apparatus 10 may be controlled by memory 14 and processor 12 to run or use the at least one prepared timing adjustment prediction model to determine the TAA or the actual TA that should be applied by the UE at the beam change. In one embodiment, apparatus 10 may be further controlled by memory 14 and processor 12 to signal, transmit or assign the TAA or the actual TA to the UE, and/or to use the TAA to adjust for or update a UE autonomously adjusted TA value at the beam change at the network.

FIG. 14B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, CPE, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 14B.

As illustrated in the example of FIG. 14B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 14B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, CPE, or the like, for example. According to certain embodiments, apparatus 20 may be controlled by memory 24 and processor 22 to perform the functions associated with any of the embodiments described herein, such as one or more of the operations illustrated in, or described with respect to, FIGS. 6-13, or any other method described herein. For example, in an embodiment, apparatus 20 may be controlled to perform a process relating to UL TA adjustment at beam switch, as described in detail elsewhere herein.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments are configured to provide methods, apparatuses and/or systems that minimize signaling for UL TA adjustment at beam switch. In other words, certain embodiments provide for the minimization of signaling overhead during beam switch. Furthermore, certain embodiments can result in the minimization of usage of PRACH resources, provide a reduction of time needed to acquire or assign correct UL TA after the beam switch, and/or provide reduced beam switch delays (e.g., faster re-start of DL and UL data transmission to the target node after beam switch). Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

Partial Glossary:

AI Artificial Intelligence

AP Access Point

BM Beam Management

CB-RA Contention-Based RA

CF-RA Contention-Free RA

CP Cyclic Prefix

CPE Customer Premises Device

CSI-RS Channel State Information Reference Signal

DU Distributed Unit

DL Downlink

DNN Deep Neural Network

FR1 Frequency Band 1

HST High-Speed Train

HO Handover

ML Machine Learning

NR New Radio (5G)

PRACH Physical Random Access Channel

RA Random Access

RRH Remote Radio Head

RS Reference Symbol

RSRP Reference Signal Received Power

SCS Sub-Carrier Spacing

SSB Synchronization Signal Block

TA Timing Advance

TAA Timing Advance Adjustment

TAC TA Command

TCI Transmission Configuration Indication

TD Transmission Delay

TRP Transmission-Reception Point

UE User Equipment

UL Uplink.

We claim:

1. An apparatus, comprising:
at least one processor; and
at least one memory comprising computer program code,
the at least one memory and computer program code configured, with the at least one processor, to cause the apparatus at least to perform:
when it is determined that beam change or transmission configuration indication (TCI) state switch should occur for one or more beams originating from non-collocated source nodes,
enabling assistance information relating to time difference for a user equipment (UE);
preparing at least one timing adjustment prediction model configured to predict a timing advance adjustment (TAA) or actual timing advance (TA) that should be applied by the user equipment (UE) at the beam change;
using the at least one prepared timing adjustment prediction model to determine the timing advance adjustment (TAA) or the actual timing advance (TA) that should be applied by the user equipment (UE) at the beam change; and
signaling or assigning the timing advance adjustment (TAA) or the actual timing advance (TA) to the user equipment (UE), or using the timing advance adjustment (TAA) to adjust for a user equipment (UE) autonomously adjusted timing advance (TA) value at the beam change.

2. The apparatus of claim 1, wherein the assistance information comprise at least one of:
reporting of user equipment (UE) measurements of propagation delay differences between the source nodes and target nodes;
reporting of timing advance (TA) value applied autonomously by the user equipment (UE);
signaling of estimated timing advance (TA) value to be used after the beam switch;
triggering a transmission of physical random access channel (PRACH) preamble for timing advance (TA) estimation on a network side;
resources for contention-free (CF) physical random access channel (PRACH) transmission;
transmission of physical random access channel (PRACH) preamble; or
user equipment (UE) reporting of reference signal received power (RSRP) measurement results from involved beams and/or relative difference of the reference signal received power (RSRP) measurement results.

3. The apparatus of claim 1, wherein the preparing of the at least one timing adjustment prediction model comprises at least one of training or updating the at least one timing adjustment prediction model using at least one of a set of timing advance adjustments (TAAs) or system parameters.

4. The apparatus of claim 3, wherein the system parameters comprise at least one of: reference signal received power (RSRP) value of a relevant reference signal (RS) used by the source nodes and target nodes, user equipment (UE) location, source or target synchronization signal block (SSB) or beam indexes, inter-remote radio head (RRH) distance, user equipment (UE) speed, user equipment (UE) capabilities, type of deployments, time difference in frame synchronization reception, timing advance (TA) estimation, currently used timing advance (TA), timing advance adjustment (TAA) information, or frequency offset (FO).

5. The apparatus of claim 1, wherein the timing adjustment prediction model comprises a deep neural network (DNN) configured to take one or more network parameters and/or UE state parameters as input, and to output at least one of the timing advance adjustment (TAA) or actual timing advance (TA) that should be applied by the user equipment at the beam change.

6. The apparatus of claim 1, wherein, when an accuracy of the output of the at least one timing adjustment prediction model is sufficient, the at least one memory and computer program code configured, with the at least one processor, to cause the apparatus at least to perform:
disabling at least one of signaling, measurements or reporting relating to timing adjustment (TA) at source node switch.

7. The apparatus of claim 1, wherein the preparing of the at least one timing adjustment prediction model comprises:
verifying the at least one timing adjustment prediction model; and
determining that a required accuracy of the output of the timing adjustment prediction model is achieved, and that the at least one timing adjustment prediction model is ready for use.

8. The apparatus of claim 1,
wherein one of the at least one timing adjustment prediction model is trained and used for an area covered by multiple cells,
wherein each of the at least one timing adjustment prediction model is trained and used on an individual cell level or individual remote radio head (RRH) level, or
wherein the at least one timing adjustment prediction model comprises a plurality of timing adjustment prediction models configured to exchange information between the models to accelerate training and avoid overfitting.

9. The apparatus of claim 1, wherein the source nodes comprise at least one of a remote radio head (RRH), transmission-reception point (TRP), or access point (AP).

10. A method, comprising:
when it is determined that beam change or transmission configuration indication (TCI) state switch should occur for one or more beams originating from non-collocated source nodes,
enabling assistance information relating to time difference for a user equipment (UE);
preparing at least one timing adjustment prediction model configured to predict a timing advance adjustment (TAA) or actual timing advance (TA) that should be applied by the user equipment (UE) at the beam change;
using the at least one prepared timing adjustment prediction model to determine the timing advance adjustment (TAA) or the actual timing advance (TA) that should be applied by the user equipment (UE) at the beam change; and
signaling or assigning the timing advance adjustment (TAA) or the actual timing advance (TA) to the user equipment (UE), or using the timing advance adjustment (TAA) to adjust for a user equipment (UE) autonomously adjusted timing advance (TA) value at the beam change.

11. The method of claim 10, wherein the assistance information comprise at least one of:
reporting of user equipment (UE) measurements of propagation delay differences between the source nodes and target nodes;
reporting of timing advance (TA) value applied autonomously by the user equipment (UE);
signaling of estimated timing advance (TA) value to be used after the beam switch;
triggering a transmission of physical random access channel (PRACH) preamble for timing advance (TA) estimation on a network side;
resources for contention-free (CF) physical random access channel (PRACH) transmission;
transmission of physical random access channel (PRACH) preamble; or
user equipment (UE) reporting of reference signal received power (RSRP) measurement results from involved beams and/or relative difference of the reference signal received power (RSRP) measurement results.

12. The method of claim 10, wherein the preparing of the at least one timing adjustment prediction model comprises at least one of training or updating the at least one timing adjustment prediction model using at least one of a set of timing advance adjustments (TAAs) or system parameters.

13. The method of claim 12, wherein the system parameters comprise at least one of: reference signal received power (RSRP) value of a relevant reference signal (RS) used by the source nodes and target nodes, user equipment (UE) location, source or target synchronization signal block (SSB) or beam indexes, inter-remote radio head (RRH) distance, user equipment (UE) speed, user equipment (UE) capabilities, type of deployments, time difference in frame synchronization reception, timing advance (TA) estimation, currently used timing advance (TA), timing advance adjustment (TAA) information, or frequency offset (FO).

14. The method of claim 10, wherein the timing adjustment prediction model comprises a deep neural network (DNN) configured to take one or more network parameters and/or UE state parameters as input, and to output at least one of the timing advance adjustment (TAA) or actual timing advance (TA) that should be applied by the user equipment at the beam change.

15. The method of claim 10, wherein, when an accuracy of the output of the at least one timing adjustment prediction model is sufficient, the method comprises:
disabling at least one of signaling, measurements or reporting relating to timing adjustment (TA) at source node switch.

16. The method of claim 10, wherein the preparing of the at least one timing adjustment prediction model comprises:
verifying the at least one timing adjustment prediction model; and
determining that a required accuracy of the output of the timing adjustment prediction model is achieved, and that the at least one timing adjustment prediction model is ready for use.

17. The method of claim 10,
wherein one of the at least one timing adjustment prediction model is trained and used for an area covered by multiple cells,
wherein each of the at least one timing adjustment prediction model is trained and used on an individual cell level or individual remote radio head (RRH) level, or
wherein the at least one timing adjustment prediction model comprises a plurality of timing adjustment prediction models configured to exchange information between the models to accelerate training and avoid overfitting.

18. The method of claim 10, wherein the source nodes comprise at least one of a remote radio head (RRH), transmission-reception point (TRP), or access point (AP).

19. A non-transitory computer readable medium comprising program instructions stored thereon for performing at least the following:
when it is determined that beam change or transmission configuration indication (TCI) state switch should occur for one or more beams originating from non-collocated source nodes,
enabling assistance information relating to time difference for a user equipment (UE);
preparing at least one timing adjustment prediction model configured to predict a timing advance adjustment (TAA) or actual timing advance (TA) that should be applied by the user equipment (UE) at the beam change;
using the at least one prepared timing adjustment prediction model to determine the timing advance adjustment (TAA) or the actual timing advance (TA) that should be applied by the user equipment (UE) at the beam change; and
signaling or assigning the timing advance adjustment (TAA) or the actual timing advance (TA) to the user equipment (UE), or using the timing advance adjustment (TAA) to adjust for a user equipment (UE) autonomously adjusted timing advance (TA) value at the beam change.
